(19) United States
(12) Patent Application Publication
(10) Pub. No.: US 2025/0238827 A1
(43) Pub. Date: Jul. 24, 2025

(54) COMPUTERIZED WEIGHTED PROBLEM IMPACT SCORE CALCULATION SYSTEM AND A METHOD THEREOF

(71) Applicant: BAHCESEHIR UNIVERSITESI, Istanbul (TR)

(72) Inventor: Oguzhan ERDINC, Istanbul (TR)

(73) Assignee: BAHCESEHIR UNIVERSITESI, Istanbul (TR)

(21) Appl. No.: 18/704,489

(22) PCT Filed: Oct. 10, 2022
(86) PCT No.: PCT/TR2022/051104

§ 371 Date: Apr. 25, 2024

(30) Foreign Application Priority Data
Oct. 25, 2021 (TR) 2021/016608

(51) Int. Cl. G06Q 30/0203

(52) U.S. Cl. CPC G06Q 30/0203

(57) ABSTRACT

The present invention relates to a computerized weighted problem impact score calculation system that is based on the user experience problems identified in the heuristic evaluation that the user experience expert applies to a digital system, and that allows for calculating the impact score using a computerized system and determining the user experience improvement priority level for the evaluated system based on this impact score, and a method thereof.

### TECHNICAL FIELD OF THE INVENTION

The present invention relates to a computerized weighted problem impact score calculation system that is based on the user experience problems identified in the heuristic evaluation that the user experience expert applies to a digital system, and that allows for calculating the impact score using a computerized system and determining the user experience improvement priority level for the evaluated system based on this impact score, and a method thereof.

### STATE OF THE ART

Heuristic Evaluation is the review of digital systems and products by a UX (user experience) expert. Researchers and practitioners have widely accepted and applied heuristic evaluation since the 90s. Basically, heuristic evaluation has two purposes, and these are; identifying user experience problems based on a predetermined set of heuristics, and rating the impact of problems and suggesting improvements for those problems. UX experts can perform heuristic evaluation, preferably in groups or individually as required. In heuristic evaluation, which is different from user testing and is a more efficient and less costly method compared to user testing, it is not required live data collection from system users, test equipment, special laboratory or test environment, and special software. More importantly, the heuristic assessment can be completed quickly, which is highly preferred under the usual time pressure in the digital industry. Computerized-Weighted Problem Impact (C-WPI) enables UX researchers and practitioners to quantify and analytically analyze the results of the heuristic UX evaluation.

The invention that is the subject of the application numbered “TR2020/01065” relates to a satisfaction evaluation method that creates user-specific questions, receives fast feedback, and uses intuitive interfaces. The method that is the subject of the invention in its most basic form comprises the process steps of; asking the user customized satisfaction questions according to the service received and personal information, providing feedback by answering the required fields from the user devices to report the satisfaction with the service received by the user, obtaining significant data sets by processing the feedback data received, and performing comprehensive data analysis depending on the satisfaction with the obtained datasets.

In the state of the art, heuristic evaluation has been applied to the practice of UX evaluations since the 90s. In heuristic evaluation, UX experts review a digital system based on a set of rules, identify UX problems, rate the severity of these problems, and offers improvements. However, conventional heuristic evaluation practices lack a unique and numerical method that can perform weighted scoring for UX problems identified during evaluation and convert this scoring result into an improvement priority level. Such weighted scoring is necessary for numerical evaluations that will greatly improve the analytical quality of the heuristic evaluation. Computerized weighted problem impact score calculation system and the method thereof provide to increase the efficiency of the evaluation effort and decision-making process for the improvement priority of the examined system.

Consequently, the disadvantages disclosed above and the inadequacy of available solutions in this regard necessitated making an improvement in the relevant technical field.

### OBJECTS OF THE INVENTION

The present invention relates to a computerized weighted problem impact score calculation system that is based on the user experience problems identified in the heuristic evaluation that the user experience experts apply to a digital system, and that allows for calculating the impact score and determining the user experience improvement priority level for the evaluated system based on this impact score, and a method thereof.

The most important object of the present invention is to allow for determining the severity levels of the detected UX problems, calculating a weighted problem impact score based on problem numbers and severity levels, and deciding the improvement priority level for the system, which will add an analytic dimension to heuristic evaluation process

Another object of the present invention is to enable UX experts to measure the impact of the problems detected in the heuristic evaluation.

Yet another object of the present invention is to perform the score calculation that defines the improvement priority level for the evaluated system based on the predetermined decision rules.

Yet another object of the present invention is to enable UX experts to enter problem impact values with the computerized system.

Yet another object of the present invention is to enable the C-WPI score to be recalculated and compared with the previous situation by repeating the heuristics evaluation after the improvements in order to analyze the impact of the UX improvements.

Yet another object of the present invention is to provide guidance to system administrators and designers on which UX issues should be given high priority in improvements.

Yet another object of the present invention is to enable it to serve as a numerical measure in such comparisons by being applied to compare the existing digital systems and products or prototypes under development.

Structural and characteristic features of the present invention as well as all advantages thereof will become clear through the attached figures and the following detailed description provided by making references thereto. Therefore, the assessment should be made by taking these figures and the detailed description into consideration.

### DESCRIPTION OF THE FIGURES

FIG. 1 illustrates a view of schematic flow diagram of the system according to the present invention.

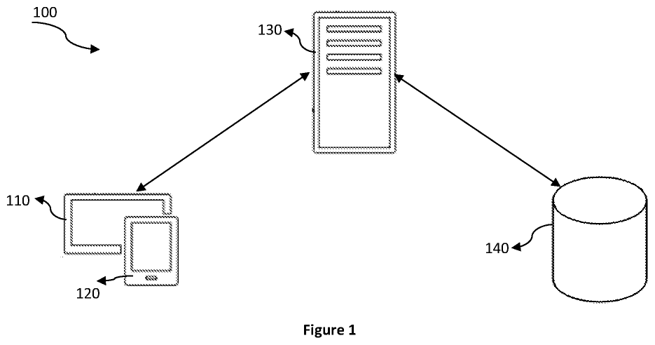

### REFERENCE NUMERALS

100. Computerized weighted problem impact score calculation system
110. Electronic device
120. Application
130. Server
140. Database

### DESCRIPTION OF THE INVENTION

The present invention relates to a computerized weighted problem impact score calculation system that is based on the user experience problems identified in the heuristic evaluation that the user experience experts apply to a digital system, and that allows for calculating the impact score and determining the user experience improvement priority level for the evaluated system based on this impact score, and a method thereof.

The value of heuristic evaluation is largely based on its outputs, which provide reliable and detailed information on UX problems and guide system improvements. In addition to the UX problem descriptions, the outputs of the heuristic evaluation should include severity levels for identified problems and suggestions for improvement. Conventional heuristic assessment practices present these outputs verbally. The computerized weighted problem impact score calculation system (100) is a numerical analysis method that will be an indicator for the UX level of the system under consideration.

The computerized weighted problem impact score calculation system (100) comprises electronic device (110), application (120), server (130), and database (140).

The electronic device (110) is a device such as a smartphone, tablet, computer that can exchange data over a data network. In an embodiment of the present invention, the electronic device (110) provides data exchange over a data network such as a wireless connection or Internet. Users provide data entries to the application (120) through the electronic device (110).

The database (140) provides a record of the information of computerized weighted problem impact score calculated by the server (130). The database (140) provides a record of questions to be asked to UX experts to determine the severity of UX problems. The database (140) provides storing the improvement priority level information calculated by the server (130).

The application (120) enables UX experts to enter the UX problems they have identified and the impact values depending on the severity level of these problems through the interface. The problem information entered here includes the description of the problem, the heuristic rule it violates, and also the effect of the problem on user performance, satisfaction, and preference. Application (120) allows UX experts to be asked questions through an interface to determine the severity level of the UX problems they have identified. The application (120) determines the severity level when a yes answer is given to the questions asked and ensures that the next question is asked to the UX experts when the answer given to the question is “no”. The application (120) first asks the UX expert whether this problem is preventing task completion or changing user preference, and if the answer to this question is yes, the severity level is determined as high, and if the answer is no, the next question is asked. Application (120) asks the UX expert whether this problem is negatively affecting user preference by causing poor user performance, and low user satisfaction, and if the answer to this question is yes, the severity level is determined as medium, if the answer is no, the next question is asked. The application (120) asks the UX expert whether this problem is just visual, or does it partially affect user performance and if the answer to this question is yes, the severity level is determined as low, and if the answer to this question is no, it presents an error message on the application (120) as “this problem may not be a UX problem, please reevaluate”. Application (120) enables UX experts to enter impact values for low, medium, and high severity levels. In an embodiment of the present invention, although the effect values of problems with application (120) low, medium and high severity levels are recommended as 1, 3, 6, respectively, and UX experts can use their own determined impact values. The computer application allows UX experts to enter the impact values through the application. The application (120) provides the weighted problem impact score calculated by the server (130) and the improvement priority level to be presented to the users via an interface.

The server (130) is in communication with the application (120) over the electronic device (110). The server 130 enables determining the severity levels given according to the answers obtained from the questions asked over the application (120). The server (130) provides obtaining the computerized weighted problem impact score (C-WPI) by summing the values obtained by multiplying the number of high severity UX problems by the high severity impact value; multiplying the number of medium severity UX problems by the medium severity impact value; and multiplying the number of low severity UX problems by the low severity impact value and by dividing this sum by the total number of problems. Server (130) ensures that the impact value determined for the high severity level is taken as the maximum possible impact score (PIₘₐₓ).

Server (130) determines the improvement priority level as “very high” if at least one high severity UX problem has been detected or if the C-WPI/PIₘₐₓ value is greater than 0.75. Server (130) determines the improvement priority level as “high” if at least one high severity UX problem has been detected or if the C-WPI/PIₘₐₓ value is between 0.50 and 0.75. Server (130) determines the improvement priority level as “medium” if high severity UX problem has not been detected or if the C-WPI/PIₘₐₓ value is between 0.25 and 0.50. Server (130) determines the improvement priority level as “low” if high severity UX problem has not been detected or if the C-WPI/PIₘₐₓ value is lower than 0.25.

The computerized weighted problem impact score calculation method includes the following process steps;
Entering the detected UX problems by UX experts into the interface presented by the application (120),
Asking questions to UX experts by the application (120) to determine the severity level of UX problems,
Determining the severity levels of UX problems according to the answers given to the questions asked by the server (130),
Entering the impact value determined by the UX experts for each severity level into the interface offered by the application (120),
Calculating the weighted problem impact score by the server (130) by using the number of problems and impact values according to the severity levels thereof,
Receiving the high severity impact value as the maximum possible problem impact score by the server (130),
Determining the improvement priority level for the examined system by the server (130) by using the maximum possible problem impact score and the computerized weighted problem impact score,
Saving in the descriptions and severity levels of the detected UX problems, the calculated improvement priority level, the maximum possible problem impact score, and the computerized weighted problem impact score into the database (140),
Presenting the system improvement priority level to the UX experts by the application (120).

In the process step of asking questions to UX experts by the application (120) to determine the severity of UX problems, the UX expert is asked by the application (120) whether this problem is preventing the completion of the task or changing user preference, and if the answer to this question is yes, the severity level is determined as high; if the answer is no, the next question is asked.

In the process step of asking questions to UX experts by the application (120) to determine the severity level of UX problems, application (120) asks the UX evaluator whether this problem effects user preference negative by leading low user performance and satisfaction, and if the answer to this question is yes, the severity level is determined as medium; if the answer is no, the next question is asked.

In the process step of asking questions to UX experts by the application (120) to determine the severity level of UX problems, the application (120) asks the UX expert whether this problem is just visual or does it partially affect user performance and if the answer to this question is yes, the severity level is determined as low, and if the answer to this question is no, it presents an error message on the application (120) as “this problem may not be a UX problem, please reevaluate”.

In the process step of entering the descriptions of UX problems determined by the UX experts into the interface offered by the application (120), UX problems comprise problems such as interface design that will cause user error, that the terms and icons used in the design are not compatible with those used in reality, failure to provide the user with the function of understanding and undoing the incorrect operation, visual design that does not provide enough feedback to the user and does not show whether the process is progressing or not, deficiencies in the navigation of the website, designs that require unnecessary processing, not remembering the user's previous actions and constantly asking for the same information, color and shape choices that are complex and challenging in interface design, error messages that do not properly prompt the user.

In the process step of determining the improvement priority level for the examined system by the server (130) by using the maximum possible problem impact score and the computerized weighted problem impact score, if at least one UX problem of high severity has been detected by the server (130), or if the value of C-WPI/PIₘₐₓ is greater than 0.75, the improvement priority level is determined as “very high”. In the process step of determining the improvement priority level for the examined system by the server (130) by using the maximum possible problem impact score and the computerized weighted problem impact score, if at least one UX problem of high severity has been detected by the server (130), or if the value of C-WPI/PIₘₐₓ is between 0.50 and 0.75, the improvement priority level is determined as “high”.

In the process step of determining the improvement priority level for the examined system by the server (130) by using the maximum possible problem impact score and the computerized weighted problem impact score, if high severity UX problem has not been detected by server (130) and if the value of C-WPI/PIₘₐₓ is between 0.25 and 0.50, the improvement priority level is determined as “medium”.

In the process step of determining the improvement priority level for the examined system by the server (130) by using the maximum possible problem impact score and the computerized weighted problem impact score, if high severity UX problem has not been detected by server (130) and if the value of C-WPI/PIₘₐₓ is less than 0.25, the improvement priority level is determined as “low”.

In the process step of calculating the weighted problem impact score by the server (130) by using the number of problems and impact values according to severity levels thereof, the computerized weighted problem impact score is calculated by summing the values obtained by multiplying the number of high severity UX problems by the high severity impact value, multiplying the number of medium severity UX problems by the medium severity impact value; and multiplying the number of low severity UX problems by the low severity impact value and by dividing this sum by the total number of problems.

In the process step of receiving the high severity impact value as the maximum possible problem impact score (PIₘₐₓ) by the server (130), the impact value determined by server (130) for the high severity UX problems is accepted as the maximum possible problem impact score.

1. A computerized weighted problem impact score calculation system (100) that allows for evaluating the user experience improvement priority for the system under review, based on user experience problems identified in the heuristic evaluation, characterized by comprising;
at least one electronic device (110) enabling that at least one application (120) is executed thereon, and enabling users to enter and exchange data,
at least one database (140) that records computerized weighted problem impact score information calculated by the server (130) and questions to be asked to UX experts in order to determine the severity of UX problems;
At least one application (120) that allows UX experts to ask questions through an interface to determine the severity of the UX problems they have identified, and that provides the weighted problem impact score calculated by the server (130) and the improvement priority level information to be presented to the users via an interface,
at least one server (130) that allows for calculating the improvement priority level by being in communication with the application (120) over the electronic device (110) and by calculating the maximum possible problems impact score and computerized weighted problem impact score with the impact value given to the severity levels and UX problems over the application (120).

2. A computerized weighted problem impact score calculation method, characterized by comprising the process steps of;
Entering the detected UX problems by UX experts into the interface presented by the application (120),
Asking questions to UX experts by the application (120) to determine the severity level of UX problems,
Determining the level of importance of UX problems according to the answers given to the questions asked by the server (130),
Entering the impact value determined by the UX experts for the problem severity levels into the interface offered by the application (120),
Calculating the weighted problem impact score by the server (130) by using the number of problems and the impact values,
Receiving the high severity impact value as the maximum possible problem impact score by the server (130),
Determining the improvement priority level for the examined system by the server (130) by using the maximum possible problem impact score and the computerized weighted problem impact score,
Saving in the descriptions and severity levels of the detected UX problems, the calculated improvement priority level, the maximum possible problem impact score, and the computerized weighted problem impact score into the database (140),
Presenting the system improvement priority level to the UX experts by the application (120).

3. A computerized weighted problem impact score calculation system (100) according to claim 1, characterized by comprising; database (140) that allows for storing the improvement priority level information calculated by the server (130).

4. A computerized weighted problem impact score calculation system (100) according to claim 1, characterized by comprising application (100) that enables UX experts to enter the UX problems they have identified and the impact values depending on the severity level of these problems through the interface.

5. A computerized weighted problem impact score calculation system (100) according to claim 1, characterized by comprising the application (120) that enables determining the severity level when the questions asked to the UX specialist is answered yes, and the next question to be asked when the answer is no (120).

6. A computerized weighted problem impact score calculation system (100) according to claim 1, characterized by comprising the application (120) that enables the UX expert to be asked whether this problem prevents the completion of the task or changes user preference, and if the answer is yes, the severity level to be determined as high, and the next question to be asked if the answer is no.

7. A computerized weighted problem impact score calculation system (100) according to claim 6, characterized by comprising the application (120) that enables the UX expert to be asked whether this problem negatively affects user preference by causing low user performance, low user satisfaction, and if the answer to this question is yes, severity level to be determined as medium, and the next question to be asked if the answer is no.

8. A computerized weighted problem impact score calculation system (100) according to claim 7, characterized by comprising the application (120) that enables the UX expert to be asked whether this problem is only visual or partially affects user performance, and if the answer is yes, the severity level to be determined as low (120), and if the answer is no, an error message to be presented on the application (120) as “this problem may not be a UX problem, please reevaluate”.

9. A computerized weighted problem impact score calculation system (100) according to claim 1, characterized by comprising the application (120) that allows UX experts to enter impact values for each of the low, medium, and high severity levels.

10. A computerized weighted problem impact score calculation system (100) according to claim 1, characterized by comprising the server (130) that allows for calculating the computerized weighted problem impact score by summing the values obtained by multiplying the number of high severity UX problems by the high severity impact value; multiplying the number of medium severity UX problems by the medium severity impact value; and multiplying the number of low severity UX problems by the low severity impact value and by dividing this sum by the total number of problems.

11. A computerized weighted problem impact score calculation system (100) according to claim 1, characterized by comprising the server (130) ensuring that the impact value determined for high severity is taken as the maximum possible impact score.

12. A computerized weighted problem impact score calculation system (100) according to claim 1, characterized by comprising the server (130) that allows for determining the improvement priority level as “very high” if at least one high severity UX problem has been detected or if the C-WPI/PIₘₐₓ value is greater than 0.75.

13. A computerized weighted problem impact score calculation system (100) according to claim 12, characterized by comprising the server (130) that allows for determining the improvement priority level as “high” if at least one high severity UX problem has been detected or if the C-WPI/PIₘₐₓ value is between 0.50 and 0.75.

14. A computerized weighted problem impact score calculation system (100) according to claim 13, characterized by comprising the server (130) that allows for determining the improvement priority level as “medium” if high severity UX problem has not been detected or if the C-WPI/PIₘₐₓ value is between 0.25 and 0.50.

15. A computerized weighted problem impact score calculation system (100) according to claim 14, characterized by comprising the server (130) that allows for determining the improvement priority level as “low” if high severity UX problem has not been detected or if the C-WPI/PIₘₐₓ value is lower than 0.25.

16. A computerized weighted problem impact score calculation method according to claim 2, characterized in that; in the process step of asking questions to UX experts by the application (120) to determine the severity of UX problems, the UX experts are asked by the application (120) whether this problem is preventing the completion of the task or changing user preference, and if the answer to this question is yes, the severity level is determined as high; if the answer is no, the next question is asked.

17. A computerized weighted problem impact score calculation method according to claim 2, characterized in that; in the process step of asking questions to UX experts by the application (120) to determine the severity level of UX problems, application (120) asks the UX expert whether this problem effects user preference negative by leading low user performance and low user satisfaction, and if the answer to this question is yes, severity level is determined as medium; if the answer is no, the next question is asked.

18. A computerized weighted problem impact score calculation method according to claim 2, characterized in that; in the process step of asking questions to UX experts by the application (120) to determine the severity level of UX problems, the application (120) asks the UX expert whether this problem is just visual or does it partially affect user performance and if the answer to this question is yes, the severity level is determined as low, and if the answer to this question is no, presenting an error message on the application (120) as “this problem may not be a UX problem, please reevaluate”.

19. A computerized weighted problem impact score calculation method according to claim 2, characterized in that; in the process step of determining the improvement priority level for the examined system by the server (130) by using the maximum possible problem impact score and the computerized weighted problem impact score, if at least one UX problem of high severity has been detected by the server (130), or if the value of C-WPI/PIₘₐₓ is greater than 0.75, the improvement priority level is determined as “very high”.

20. A computerized weighted problem impact score calculation method according to claim 2, characterized in that; in the process step of determining the improvement priority level for the examined system by the server (130) by using the maximum possible problem impact score and the computerized weighted problem impact score, if at least one UX problem of high severity has been detected by the server (130), or if the value of C-WPI/PIₘₐₓ is between 0.50 and 0.75, the improvement priority level is determined as “high”.

21. A computerized weighted problem impact score calculation method according to claim 2, characterized in that; in the process step of determining the improvement priority level for the examined system by the server (130) by using the maximum possible problem impact score and the computerized weighted problem impact score, if high severity UX problem has not been detected by server (130) and if the value of C-WPI/PIₘₐₓ is between 0.25 and 0.50, the improvement priority level is determined as “medium”.

22. A computerized weighted problem impact score calculation method according to claim 2, characterized in that; in the process step of determining the improvement priority level for the examined system by the server (130) by using the maximum possible problem impact score and the computerized weighted problem impact score, if high severity UX problem has not been detected by server (130) and if the value of C-WPI/PIₘₐₓ is less than 0.25, the improvement priority level is determined as “low”.

23. A computerized weighted problem impact score calculation method according to claim 2, characterized in that; in the process step of calculating the weighted problem impact score by the server (130) by using the impact values according to the number of problems and the severity levels thereof, the computerized weighted problem impact score is calculated by summing the values obtained by multiplying the number of high severity UX problems by the high severity impact value, multiplying the number of medium severity UX problems by the medium severity impact value; and multiplying the number of low severity UX problems by the low severity impact value and by dividing this sum by the total number of problems.

24. A computerized weighted problem impact score calculation method according to claim 2, characterized in that; in the process step of receiving the high severity impact value as the maximum possible problem impact score (PIₘₐₓ) by the server (130), the impact value determined by server (130) for the high severity UX problems is accepted as the maximum possible problem impact score.

25. A computerized weighted problem impact score calculation method according to claim 2, characterized in that; in the process step of entering the UX problem descriptions determined by the UX experts into the interface offered by the application (120), UX problems are the problems such as interface design that will cause user error, that the terms and icons used in the design are not compatible with those used in reality, failure to provide the user with the function of understanding and undoing the incorrect operation, visual design that does not provide enough feedback to the user and does not show whether the process is progressing or not, deficiencies in the navigation of the website, designs that require unnecessary processing, not remembering the user's previous actions and constantly asking for the same information, color and shape choices that are complex and challenging in interface design, error messages that do not properly prompt the user.
